(19) United States
(12) Patent Application Publication
(10) Pub. No.: US 2026/0148539 A1
(43) Pub. Date: May 28, 2026

(54) DETECTING AND CORRECTING LABEL NOISE IN SEGMENTATION DATA

(71) Applicant: UnitX, Inc., Santa Clara, CA (US)

(72) Inventor: Di Meng, Santa Clara, CA (US)

(21) Appl. No.: 18/957,173

(22) Filed: Nov. 22, 2024

(51) Int. Cl. G06V 10/82; G06V 10/776; G06V 10/778; G06V 20/70

(52) U.S. Cl. CPC G06V 10/82; G06V 10/776; G06V 10/7788; G06V 20/70

(57) ABSTRACT

In an example embodiment, each sample's loss is monitored during training of the segmentation model, and the amount of each sample's loss is used to determine which samples are mislabeled. For each pixel in each epoch, a logit of the model prediction class and a logit of the label class are determined, and the difference between them (margin) determined and saved. The margin then can be integrated over all epochs to derive an area under the margin (AUM) score for each pixel. A softmax function can then be applied to each sample to obtain an AUM score for each sample. Any images whose AUM score is greater than a predetermined threshold may be determined to be mislabeled and appropriate action can then be taken to fix the mislabeling, thus resulting in more accurate training and validation of the segmentation model.

### TECHNICAL FIELD

This application relates generally to machine learning. More particularly, this application relates to the detection and correcting of label noise in segmentation data used to train and/or validate a machine learning segmentation model.

### BACKGROUND

Machine learning can be used in a variety of applications to perform various classification actions on digital images. One such classification is to identify “defects” in items appearing in the digital images. For example, a manufacturer may capture images of a product or part on an assembly line and use a machine learning model to identify whether the product or part has a defect that necessitates correction or destruction of the product.

Traditionally, training of such models has utilized two-dimensional images, but most of the products or parts being evaluated are three dimensional in nature, and have points, lines, and curves that may not be easily understood by a model trained using only two-dimensional images.

### BRIEF DESCRIPTION OF DRAWINGS

FIG. 1 is a diagram illustrating an image showing a product, in accordance with an example embodiment.

FIG. 2 is a diagram illustrating a mask over a product image, in accordance with an example embodiment.

FIG. 3 is a block diagram illustrating a system for training a segmentation model, in accordance with an example embodiment.

FIG. 4 is a flow diagram illustrating a method for training a segmentation model, in accordance with an example embodiment.

FIG. 5 is a block diagram illustrating a software architecture, which can be installed on any one or more of the devices described above.

FIG. 6 illustrates a diagrammatic representation of a machine in the form of a computer system within which a set of instructions may be executed for causing the machine to perform any one or more of the methodologies discussed herein.

### DETAILED DESCRIPTION

The description that follows includes illustrative systems, methods, techniques, instruction sequences, and computing machine program products that have illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Defect detection of products in an assembly line or similar environment may be performed using one more artificial intelligence models.

One particular way that artificial intelligence models are used in defect detection is through a segmentation model. The goal of a segmentation model is to segment an image into smaller segments to improve reliability of subsequent modeling (such as subsequent classification and defect detection models). Thus, for example, a segmentation model may be used to identify particular portions of an image that are likely to have defects, which then allows the subsequent classification and defect detection models to only focus on those particular portions of the image (or at least use the segments in its analysis).

Training of a segmentation model involves using training data with a machine learning algorithm. The training data may be labeled (such as labeled with indications of which segments of each image in the training data are likely to have defects). The labels may be stored in the form of masks, which essentially are overlays on the image with areas of interest highlighted or marked in some way, as well as some classification (label) of the areas of interest. For example, a particular defect in a product in a sample image may be circled and classified as “defect”, while the remaining part of the image showing the product may be classified as “non-defect” and any non-product part (e.g., part of an assembly line) of the image classified as “non-product”. The machine learning algorithm then repeatedly modifies weights and other parameters in the segment model until it is “trained” to accurately predict the segments of interest in the training data. At that point, the segmentation model is considered trained and can be used to evaluate images that have no labels (e.g., new images taken after the segmentation model has been trained). Furthermore, some of the “training data” may be held back and not actually be used for training, but instead be used for validation, such as to validate that the segmentation model has been properly trained after training. That data, while similar or identical to training data, may be termed “validation data.”

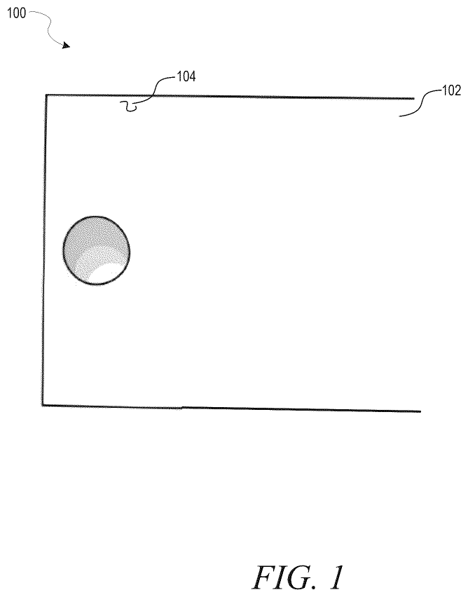

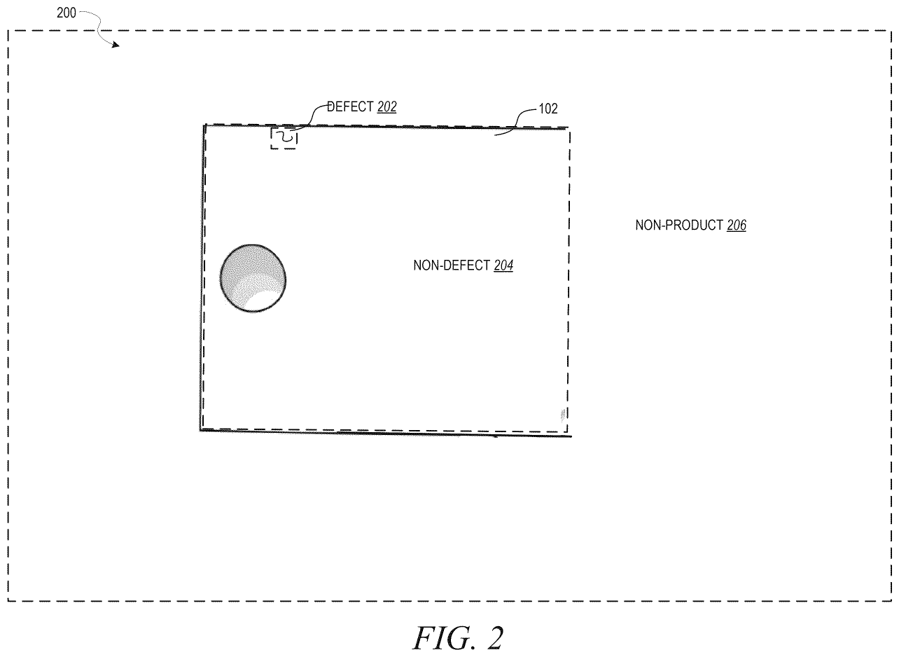

FIG. 1 is a diagram illustrating an image 100 showing a product 102, in accordance with an example embodiment. Here, the product is shown to have a defect 104. FIG. 2 is a diagram illustrating a mask 200 over a product image, in accordance with an example embodiment. Specifically, the mask 200 delineates three portions. Each portion is depicted as bordered by dashed lines, which are not actually present in the mask but are provided to be able to tell where one portion ends and another begins. The first portion 202 is labeled as “non-product”, specifically the portion of the image that does not contain the product. The second portion 204 is labeled as “non-defect,” specifically the portion of the image that contains the product but that represents the non-defective portion of the product. The third portion 206 is labeled as “defect,” specifically the portion of the image that contains the defective portion of the product.

A technical issue that arises with the training of segmentation models is due to the fact that there may be noise in the labels/masks (for labels this may mean the delineated portions are mislabeled while for masks this may mean the portions are incorrectly delineated). Noise in this context refers to some sort of erroneous information that makes the label or mask incorrect in some way. This may be from, for example, an incorrect classification applied to an area of interest (e.g., labeled as a defect when it is not) or an inaccurately defined area of interest (e.g., the area of interest erroneously includes some portion that is not of interest, or misses some portion that is of interest). These types of noise in the segmentation data can then lead to incorrect training and/or validation of the segmentation model, resulting in a segmentation model that produces inaccurate or at least suboptimal accuracy results.

Each piece of segmentation data used for either training or validation may be termed a “sample.”

In an example embodiment, each sample's loss is monitored during training of the segmentation model, and the amount of each sample's loss is used to determine which samples are mislabeled. More particularly, the samples and corresponding masks are provided as input. For each pixel in each epoch (iteration of the training), a logit of the model prediction class and a logit of the label class are determined. A margin comprising the difference between the logit of the model prediction class and the logit of the label class is then determined and saved. The margin then can be integrated over all epochs to derive an area under the margin (AUM) score for each pixel. A softmax, or similar function, can then be applied to each sample to obtain an AUM score for each sample. The samples can then be ranked based on their AUM scores and any images whose AUM score is greater than a predetermined threshold may be determined to be mislabeled, and appropriate action can then be taken to fix the mislabeling thus resulting in more accurate training and validation of the segmentation model.

Thus, for example, if the image in FIG. 2 is determined to have an AUM score greater than the threshold, then it assumes that something in the mask is incorrect, whether it be the locations/sizes of the different portions or the labels themselves.

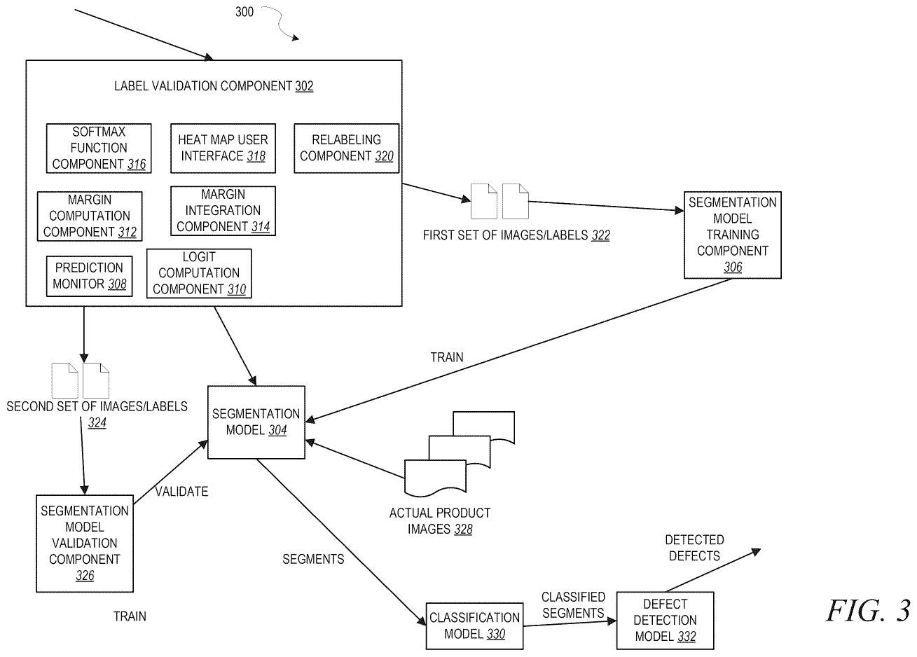

FIG. 3 is a block diagram illustrating a system 300, in accordance with an example embodiment. One or more training images and corresponding masks are passed to a label validation component 302. The label validation component 302 acts to detect noise in the labels of the training images and corresponding masks. More specifically, the label validation component 302 acts to identify images in which the masks either have incorrectly drawn borders or have incorrectly assigned classifications.

The label validation component 302 monitors the training of a segmentation model 304 as performed by a segmentation model training component 306. The segmentation model 304 can be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the machine learning algorithm used to train the segmentation model 304 may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the segmentation model 304 may take place as a dedicated training phase. In other example embodiments, the segmentation model may be retrained dynamically at runtime based on feedback.

In an example embodiment, the segmentation model 304 is a neural, and the training performed by the segmentation model training component 306 may include iteratively performing a forward pass, loss computation, back propagation, and optimization. The forward pass involves passing input data through the network to obtain predictions. It includes feeding the images into the model, with each layer of the neural network applying a transformation (e.g., convolution, activation function). The output from the final layer is the model's prediction (e.g., segmentation masks).

Loss Computation quantifies how well the model's predictions match the ground truth labels. A loss function is defined (e.g., cross-entropy for classification tasks, Dice loss for segmentation). The loss function takes the model's predictions and the labels as inputs. It computes a scalar value representing the error: lower values indicate better performance.

Backpropagation is the algorithm used to update the model's parameters (weights) based on the loss computed. Gradients of the loss with respect to each weight in the network are computed using the chain rule of calculus. This involves propagating the loss backward through the network. Specifically, starting from the output layer, the gradient of the loss is calculated with respect to the output. Gradients are then passed backward through each layer to compute the gradients for all weights. The gradients indicate how to change each weight to reduce the loss.

Optimization is the process of updating the model parameters using the gradients computed during backpropagation. An optimizer (e.g., SGD, Adam, RMSprop) is used to update the weights based on the computed gradients. The update rule typically involves adjusting the weights in the opposite direction of the gradient. Updated weights are used for the next forward pass, continuing the cycle of training until the model converges.

Each iteration of the forward pass, loss computation, backpropagation, and optimization is performed on all of the images/masks in a training set. Each such iteration is also called an epoch.

As mentioned earlier, the label validation component 302 monitors this training process. More specifically, a prediction monitor 308 monitors the predictions made for each pixel during the forward pass. A logit computation component 310 then computes a logit of the prediction for a pixel along with the logit of the label for the pixel from the corresponding mask. A logit a pre-softmax output. Segmentation models generate a vector for each pixel, whose length equals the number of classes to predict. These vectors will get passed into a softmax function to be turned into a probability distribution. Here the logit includes the vectors before operated on by the softmax function.

A margin computation component 312 then computes a margin for each pixel, for each epoch. The margin is the difference between the logit of the prediction for a pixel along with the logit of the label for the pixel from the corresponding mask.

The result is that a margin has been computed for each pixel for each epoch. A margin integration component 314 then, for each pixel, integrates the margins for all the epochs. The result of this integration is an AUM score for the pixel. A softmax function component 316 then applies a softmax function to the AUM scores pixels in each image to obtain an AUM score for each image as a whole. Images with an AUM score greater than a threshold are considered to have been mislabeled in some way. The threshold may be manually set or may be itself learned via machine learning. For example, a threshold of 0.90 means that images having AUM scores greater than 0.90 are considered to be mislabeled. A user can simply set this threshold level manually, or a machine learning algorithm can learn the best threshold under the circumstances. Specifically, this threshold machine learning model can be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the machine learning algorithm used to train the threshold machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the threshold machine learning model may take place as a dedicated training phase. In other example embodiments, the threshold machine learning model may be retrained dynamically at runtime based on feedback.

In some example embodiments, images with an AUM greater than the threshold are simply discarded/not used for training or validation until new label(s) are applied to them. In some example embodiments, a heat map user interface 318 may be introduced to aid in the relabeling of an image. The heat map user interface 318 may generate a colored heatmap for an image that needs to be mislabeled. The colored heatmap acts as an overlay over the image and the colors indicate the probability that the underlying pixels are mislabeled. In this way, for example, a user may be able to see which portions of the image are likeliest to be mislabeled, allowing for more efficient and effective relabeling.

In some example embodiments, the relabeling may be performed automatically without user intervention.

Regardless of how relabeling occurs, the relabeling component 320 may apply the new label(s) to the image(s). The relabeled images may then be used along with images whose AUM score did not exceed the threshold as training images or validation images for the segmentation model.

More specifically, a first set of these images/labels 322 is then passed to the segmentation model training component 306 to train the segmentation model 304. A second set of these images/labels 324 is then passed to a segmentation model validation component 326 to validate the segmentation model 304. Once validated, the segmentation model 304 can then be used to evaluate actual product images 328 and segment the actual product images 328 into segments. Optionally, a classification model 330 then classifies the segments and a defect detection model 332 detects one or more defects in the classified segments. In some example embodiments, the outputs of the segmentation model 304 already contain classification information and thus a separate classification model 330 is not needed.

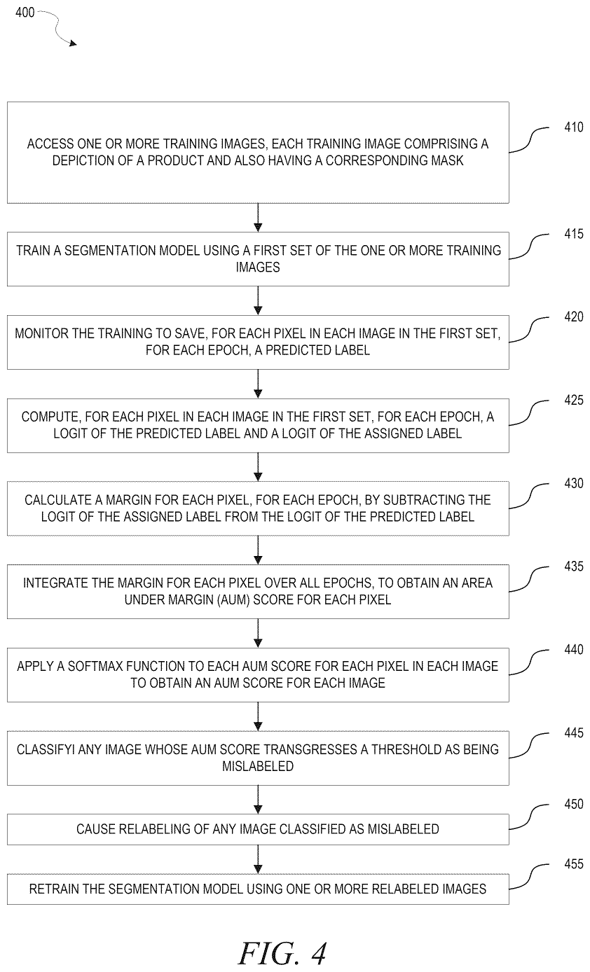

FIG. 4 is a flow diagram illustrating a method 400 for training a segmentation model, in accordance with an example embodiment.

At operation 410, one or more training images are accessed. Each training image comprises a depiction of a product and also has a corresponding mask, wherein the corresponding mask provides an assigned label for one or more portions of the training image.

At operation 415, a segmentation model is trained using a first set of the one or more training images. At operation 420, the training is monitored to save, for each pixel, in each image in the first set, for each epoch, a predicted label.

At operation 425, for each pixel in each image in the first set, for each epoch, a logit of the predicted label and a logit of the assigned label are computed. At operation 430, a margin is calculated for each pixel, for each epoch, by subtracting the logit of the assigned label from the logit of the predicted label.

At operation 435, the margin for each pixel over all epochs is integrated, to obtain an Area Under Margin (AUM) score for each pixel.

At operation 440, a softmax function is applied to each AUM score for each pixel in each image to obtain an AUM score for each image. At operation 445, any image whose AUM score transgresses a threshold is classified as being mislabeled.

At operation 450, any image classified as mislabeled is relabeled. At operation 455, the segmentation model is retrained using one or more relabeled images.

In view of the disclosure above, various examples are set forth below. It should be noted that one or more features of an example, taken in isolation or combination, should be considered within the disclosure of this application.

Example 1 is a system comprising: one or more image data sources; a computer system comprising at least one hardware processor and a non-transitory computer-readable medium storing instructions that, when executed by the at least one hardware processor, cause the at least one hardware processor to perform operations comprising: accessing one or more training images, each training image comprising a depiction of a product and also having a corresponding mask, wherein the corresponding mask provides an assigned label for one or more portions of the training image; training a segmentation model using a first set of the one or more training images; monitoring the training to save, for each pixel in each image in the first set, for each epoch, a predicted label; computing, for each pixel in each image in the first set, for each epoch, a logit of the predicted label and a logit of the assigned label; calculating a margin for each pixel, for each epoch, by subtracting the logit of the assigned label from the logit of the predicted label; integrating the margin for each pixel over all epochs, to obtain an Area Under Margin (AUM) score for each pixel; applying a softmax function to each AUM score for each pixel in each image to obtain an AUM score for each image; classifying any image whose AUM score transgresses a threshold as being mislabeled; causing relabeling of any image classified as mislabeled; retraining the segmentation model using one or more relabeled images.

In Example 2, the subject matter of Example 1 comprises, wherein the segmentation model is a neural network.

In Example 3, the subject matter of Example 2 comprises, wherein the predicted label is generated during a forward pass where one or more layers of the neural network apply a transformation.

In Example 4, the subject matter of Example 3 comprises, wherein the transformation comprises a convolution.

In Example 5, the subject matter of Examples 3-4 comprises, wherein the transformation comprises an activation.

In Example 6, the subject matter of Examples 1-5 comprises, wherein the threshold is leaned via machine learning of a machine learning model.

In Example 7, the subject matter of Examples 1-6 comprises, wherein the causing relabeling comprises generating a user interface displaying an image with a corresponding heat map overlaid over the image, the heat map indicating which pixels of the image are likeliest to be mislabeled.

Example 8 is a method comprising: accessing one or more training images, each training image comprising a depiction of a product and also having a corresponding mask, wherein the corresponding mask provides an assigned label for one or more portions of the training image; training a segmentation model using a first set of the one or more training images; monitoring the training to save, for each pixel in each image in the first set, for each epoch, a predicted label; computing, for each pixel in each image in the first set, for each epoch, a logit of the predicted label and a logit of the assigned label; calculating a margin for each pixel, for each epoch, by subtracting the logit of the assigned label from the logit of the predicted label; integrating the margin for each pixel over all epochs, to obtain an Area Under Margin (AUM) score for each pixel; applying a softmax function to each AUM score for each pixel in each image to obtain an AUM score for each image; classifying any image whose AUM score transgresses a threshold as being mislabeled; causing relabeling of any image classified as mislabeled; retraining the segmentation model using one or more relabeled images.

In Example 9, the subject matter of Example 8 comprises, wherein the segmentation model is a neural network.

In Example 10, the subject matter of Example 9 comprises, wherein the predicted label is generated during a forward pass where one or more layers of the neural network apply a transformation.

In Example 11, the subject matter of Example 10 comprises, wherein the transformation comprises a convolution.

In Example 12, the subject matter of Examples 10-11 comprises, wherein the transformation comprises an activation.

In Example 13, the subject matter of Examples 8-12 comprises, wherein the threshold is leaned via machine learning of a machine learning model.

In Example 14, the subject matter of Examples 8-13 comprises, wherein the causing relabeling comprises generating a user interface displaying an image with a corresponding heat map overlaid over the image, the heat map indicating which pixels of the image are likeliest to be mislabeled.

Example 15 is a non-transitory machine-readable storage medium having embodied thereon instructions executable by one or more machines to perform operations comprising: accessing one or more training images, each training image comprising a depiction of a product and also having a corresponding mask, wherein the corresponding mask provides an assigned label for one or more portions of the training image; training a segmentation model using a first set of the one or more training images; monitoring the training to save, for each pixel in each image in the first set, for each epoch, a predicted label; computing, for each pixel in each image in the first set, for each epoch, a logit of the predicted label and a logit of the assigned label; calculating a margin for each pixel, for each epoch, by subtracting the logit of the assigned label from the logit of the predicted label; integrating the margin for each pixel over all epochs, to obtain an Area Under Margin (AUM) score for each pixel; applying a softmax function to each AUM score for each pixel in each image to obtain an AUM score for each image; classifying any image whose AUM score transgresses a threshold as being mislabeled; causing relabeling of any image classified as mislabeled; and, retraining the segmentation model using one or more relabeled images.

In Example 16, the subject matter of Example 15 comprises, wherein the segmentation model is a neural network.

In Example 17, the subject matter of Example 16 comprises, wherein the predicted label is generated during a forward pass where one or more layers of the neural network apply a transformation.

In Example 18, the subject matter of Example 17 comprises, wherein the transformation comprises a convolution.

In Example 19, the subject matter of Examples 17-18 comprises, wherein the transformation comprises an activation.

In Example 20, the subject matter of Examples 15-19 comprises, wherein the threshold is leaned via machine learning of a machine learning model.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

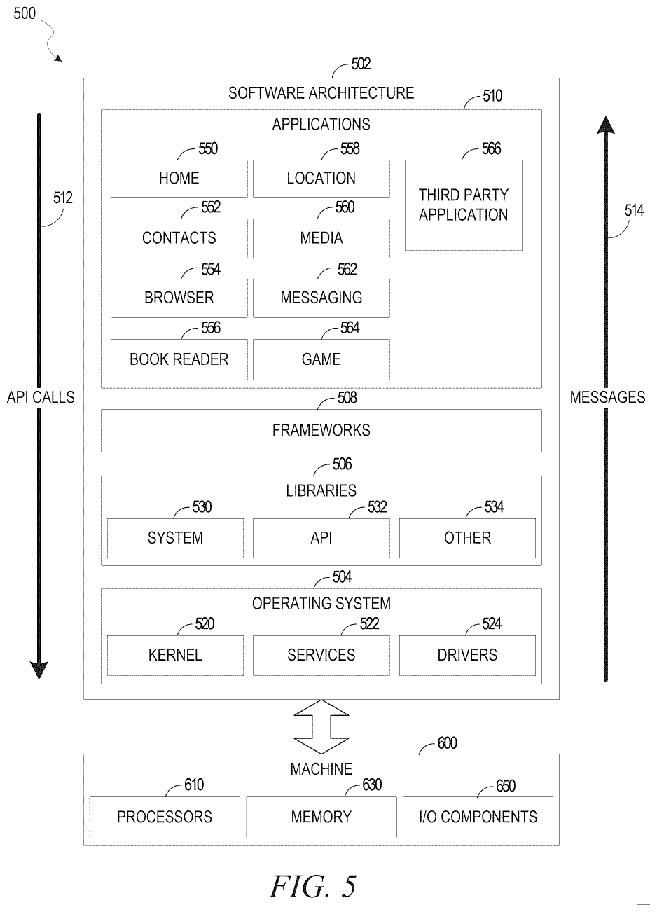

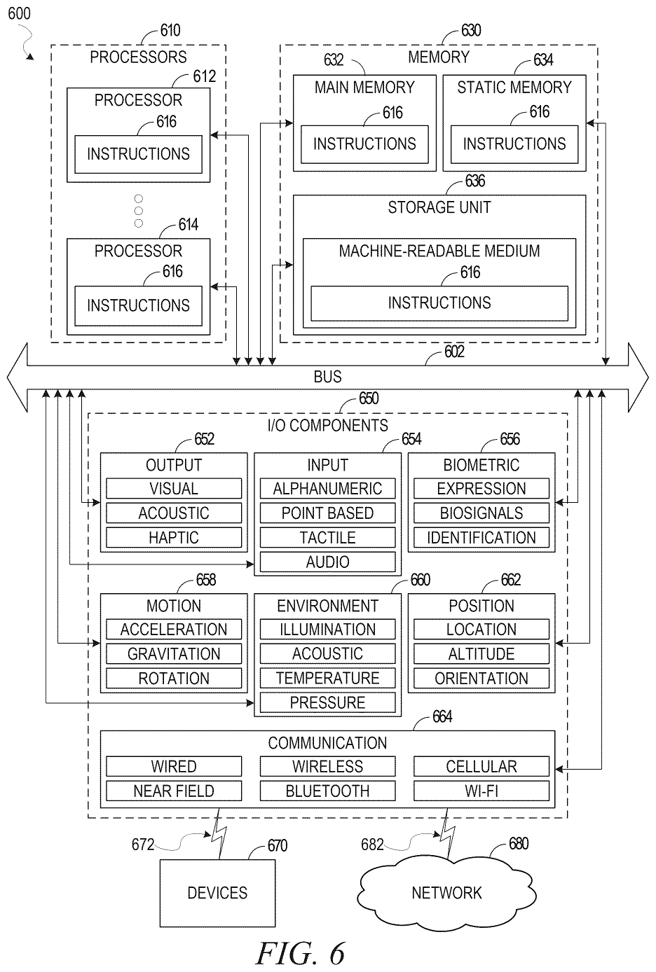

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke Application Program Interface (API) calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionalities. The services 522 can provide other common services for the other software layers. The drivers 524 are responsible for controlling or interfacing with the underlying hardware. For instance, the drivers 524 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510. For example, the frameworks 508 provide various graphical user interface functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. The applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) cause the machine 600 to perform any one or more of the methodologies discussed herein to be executed. For example, the instructions 616 may cause the machine 600 to execute the method 400 of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may include a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or include components operable to detect identifiers. For example, the communication components 664 may include radio-frequency identification (RFID) tag reader components, NFC smart tag detection components, optical reader components (e.g., an optical sensor to detect one-dimensional bar codes such as Universal Product Code (UPC) bar codes, multi-dimensional bar codes such as QR code, Aztec codes, Data Matrix, Dataglyph, Maxi Code, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (e.g., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 5G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., Hypertext Transfer Protocol (HTTP)). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
one or more image data sources;
a computer system comprising at least one hardware processor and a non-transitory computer-readable medium storing instructions that, when executed by the at least one hardware processor, cause the at least one hardware processor to perform operations comprising:
accessing one or more training images, each training image comprising a depiction of a product and also having a corresponding mask, wherein the corresponding mask provides an assigned label for one or more portions of the training image;
training a segmentation model using a first set of the one or more training images;
monitoring the training to save, for each pixel in each image in the first set, for each epoch, a predicted label;
computing, for each pixel in each image in the first set, for each epoch, a logit of the predicted label and a logit of the assigned label;
calculating a margin for each pixel, for each epoch, by subtracting the logit of the assigned label from the logit of the predicted label;
integrating the margin for each pixel over all epochs, to obtain an Area Under Margin (AUM) score for each pixel;
applying a softmax function to each AUM score for each pixel in each image to obtain an AUM score for each image;
classifying any image whose AUM score transgresses a threshold as being mislabeled;
causing relabeling of any image classified as mislabeled; and
retraining the segmentation model using one or more relabeled images.

2. The system of claim 1, wherein the segmentation model is a neural network.

3. The system of claim 2, wherein the predicted label is generated during a forward pass where one or more layers of the neural network apply a transformation.

4. The system of claim 3, wherein the transformation comprises a convolution.

5. The system of claim 3, wherein the transformation comprises an activation.

6. The system of claim 1, wherein the threshold is leaned via machine learning of a machine learning model.

7. The system of claim 1, wherein the causing relabeling comprises generating a user interface displaying an image with a corresponding heat map overlaid over the image, the heat map indicating which pixels of the image are likeliest to be mislabeled.

8. A method comprising:
accessing one or more training images, each training image comprising a depiction of a product and also having a corresponding mask, wherein the corresponding mask provides an assigned label for one or more portions of the training image;
training a segmentation model using a first set of the one or more training images;
monitoring the training to save, for each pixel in each image in the first set, for each epoch, a predicted label;
computing, for each pixel in each image in the first set, for each epoch, a logit of the predicted label and a logit of the assigned label;
calculating a margin for each pixel, for each epoch, by subtracting the logit of the assigned label from the logit of the predicted label;
integrating the margin for each pixel over all epochs, to obtain an Area Under Margin (AUM) score for each pixel;
applying a softmax function to each AUM score for each pixel in each image to obtain an AUM score for each image;
classifying any image whose AUM score transgresses a threshold as being mislabeled;
causing relabeling of any image classified as mislabeled; and
retraining the segmentation model using one or more relabeled images.

9. The method of claim 8, wherein the segmentation model is a neural network.

10. The method of claim 9, wherein the predicted label is generated during a forward pass where one or more layers of the neural network apply a transformation.

11. The method of claim 10, wherein the transformation comprises a convolution.

12. The method of claim 10, wherein the transformation comprises an activation.

13. The method of claim 8, wherein the threshold is leaned via machine learning of a machine learning model.

14. The method of claim 8, wherein the causing relabeling comprises generating a user interface displaying an image with a corresponding heat map overlaid over the image, the heat map indicating which pixels of the image are likeliest to be mislabeled.

15. A non-transitory machine-readable storage medium having embodied thereon instructions executable by one or more machines to perform operations comprising:
accessing one or more training images, each training image comprising a depiction of a product and also having a corresponding mask, wherein the corresponding mask provides an assigned label for one or more portions of the training image;
training a segmentation model using a first set of the one or more training images;
monitoring the training to save, for each pixel in each image in the first set, for each epoch, a predicted label;
computing, for each pixel in each image in the first set, for each epoch, a logit of the predicted label and a logit of the assigned label;
calculating a margin for each pixel, for each epoch, by subtracting the logit of the assigned label from the logit of the predicted label;
integrating the margin for each pixel over all epochs, to obtain an Area Under Margin (AUM) score for each pixel;
applying a softmax function to each AUM score for each pixel in each image to obtain an AUM score for each image;
classifying any image whose AUM score transgresses a threshold as being mislabeled;
causing relabeling of any image classified as mislabeled; and
retraining the segmentation model using one or more relabeled images.

16. The non-transitory machine-readable storage medium of claim 15, wherein the segmentation model is a neural network.

17. The non-transitory machine-readable storage medium of claim 16, wherein the predicted label is generated during a forward pass where one or more layers of the neural network apply a transformation.

18. The non-transitory machine-readable storage medium of claim 17, wherein the transformation comprises a convolution.

19. The non-transitory machine-readable storage medium of claim 17, wherein the transformation comprises an activation.

20. The non-transitory machine-readable storage medium of claim 15, wherein the threshold is leaned via machine learning of a machine learning model.
